(19) United States
(12) Patent Application Publication
(10) Pub. No.: US 2007/0075908 A1
(43) Pub. Date: Apr. 5, 2007

(54) ELECTROMAGNETIC MEASUREMENT PROBE AND METHOD

(76) Inventors: Prem K. Ganeshan, Arlington Heights, IL (US); James P. Phillips, Lake in the Hills, IL (US); Hugh K. Smith, Palatine, IL (US)

Correspondence Address: MOTOROLA INC, 600 NORTH US HIGHWAY 45, ROOM AS437, LIBERTYVILLE, IL, 60048-5343, US

(21) Appl. No.: 11/241,171

(22) Filed: Sep. 30, 2005

(51) Int. Cl. H01Q 21/26

(52) U.S. Cl. 343/797

(57) ABSTRACT

An electromagnetic field probe is provided that is capable of measuring four electromagnetic field components in a spatial plane tangential to the central axis of the probe. The probe included two dipoles and two loops. The dipoles are disposed about the central axis at substantially 90 degree angles, while the loops are disposed from 45 to 225 and from 135 to 315 degrees, respectively. In one embodiment, a plurality of flexible conductors, signal combiners and switches are used to couple the dipoles and loops to a network or spectrum analyzer. To isolate the effects of field components that are incident to the central axis of the probe, a 180 degree signal combiner may be employed to separate the common mode signals.

### BACKGROUND

1. Technical Field

This invention relates generally to electromagnetic field probes, and more specifically to a probe capable of measuring four tangential electric and magnetic field components from one spatial location.

2. Background Art

Measurement of electrical fields has long been necessary in the development of radio frequency (RF) devices. For example, to calculate the efficiency of an antenna, one must measure the strength of the radiated field to know how much of the power delivered from radio to antenna will be transmitted through the air.

For many years, manufacturers have produced “dipole” sensors that are capable of measuring the magnitude of an electric field radiated by antennae and other objects. These dipoles are generally two L-shaped pieces of wire that serve as small, receiving antennae. The dipoles are electrically isolated and placed in close proximity in the air.

The dipoles conduct the oscillating RF signals from the air. In the typical prior art solution, these oscillating signals are then coupled to a circuit that is capable of sensing and displaying only the magnitude of the detected power, as the circuit rectifies the signal with a diode, smoothes it with a filtering capacitor, and then feeds the smoothed, rectified signal into a high input impedance amplifier. Such a circuit may be well suited to measuring the amplitude of one component of the radiated electric field. Alternately, small loops may be substituted for the dipoles to measure the magnetic field intensity.

There are two problems with such a prior art solution, however. First, since the signal is rectified and coupled to a high impedance node (the amplifier input), only the amplitude may be measured. The designer or engineer loses all phase information and much of the information associated with the spectrum of the signal. The phase between the electric and magnetic fields is a critical parameter that is not available with dipole probes alone. Second, the high impedance node may negatively affect the desired measurement.

There is thus a need for an improved electromagnetic probe capable of sensing all the tangential electromagnetic field, both electric and magnetic, without losing phase or spectrum information.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a perspective view of one embodiment of a probe in accordance with the invention.

FIG. 2 illustrates a bottom, plan view of one embodiment of a probe in accordance with the invention.

FIG. 3 illustrates a side, elevation view of one embodiment of a probe in accordance with the invention.

FIG. 4 illustrates one embodiment of an application for a probe in accordance with the invention.

FIG. 5 illustrates an alternate embodiment of an application for a probe in accordance with the invention.

FIG. 6 illustrates a method in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations and apparatus components and method steps related to a probe capable of sensing both total electric and magnetic tangential fields. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional pieces of lab equipment and known program instructions that control the lab equipment. The equipment components include vector network analyzers and spectrum analyzers. Further, it is expected that one of ordinary skill, notwithstanding possibly significant effort and many design choices motivated by, for example, available time, current technology, and economic considerations, when guided by the concepts and principles disclosed herein will be readily capable of making and using the invention with minimal experimentation.

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

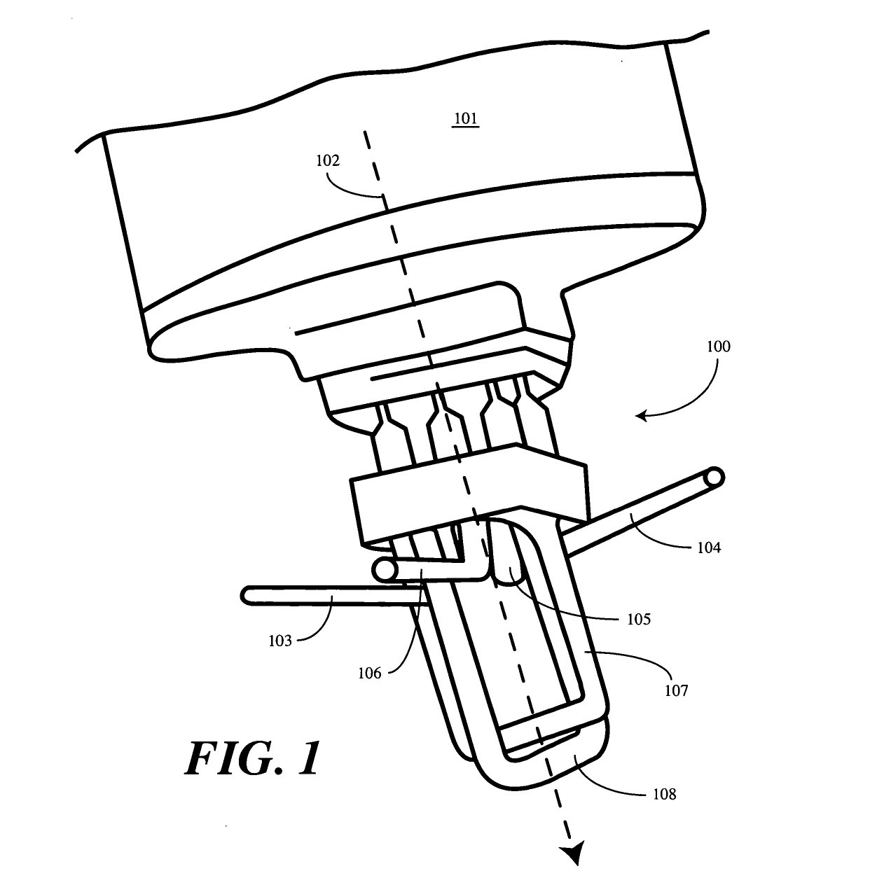

Referring now to FIGS. 1-3, illustrated therein is an electromagnetic measurement probe 100 in accordance with one embodiment of the invention. The electromagnetic measurement probe 100 includes a central member 101 that is disposed along a central axis 102. The central axis 102 a reference line for discussion purposes, as there will be several alignments and geometric relationships relative to the central axis 102 of the probe 100 in the discussion below.

The probe 100 has a first dipole that includes a first pole 103, and a second pole 104. In one embodiment, the length of the poles 103, 104 are designed not to exceed one-tenth of a wavelength at the highest frequency of measurement. The first pole 103 extends outwardly from the central axis 102 at an angle 301 (FIG. 3) of between 86.8 and 93.2 degrees relative to the central axis 102. The closer the angle 301 is to 90 degrees, the better the performance of the probe 100 will be, as nearly orthogonal angles have been shown to deliver good results. However, the realities of manufacture mean that an angle 301 of exactly 90 degrees is nearly impossible to obtain. Even with a six sigma manufacturing process, real machines may dispose the first pole 103 at an angle 301 of 90.001 or 89.999 degrees relative to the central axis 102. For this reason, several angle ranges, acceptable in terms of both measurement and manufacture, will be discussed herein.

Calculations show that an angle 301 within 3.2 degrees of the orthogonal still yields measurements within 0.5 dB of the optimum. For most measurement and testing, 0.5 dB is well within the range of acceptable error. As such, many of the measurements described herein are in ranges of 3.2 degrees about an orthogonal. Note, however, that as the angles get closer to multiples of 90 degrees (or 45 in the case of the loops), the performance improves.

The second pole 104 also extends outwardly from the central axis 102 at an angle 302 of between 86.8 and 93.2 degrees relative to the central axis 102. Again, an angle 302 of 90 degrees will yield improved performance, but angles in this range have shown satisfactory results.

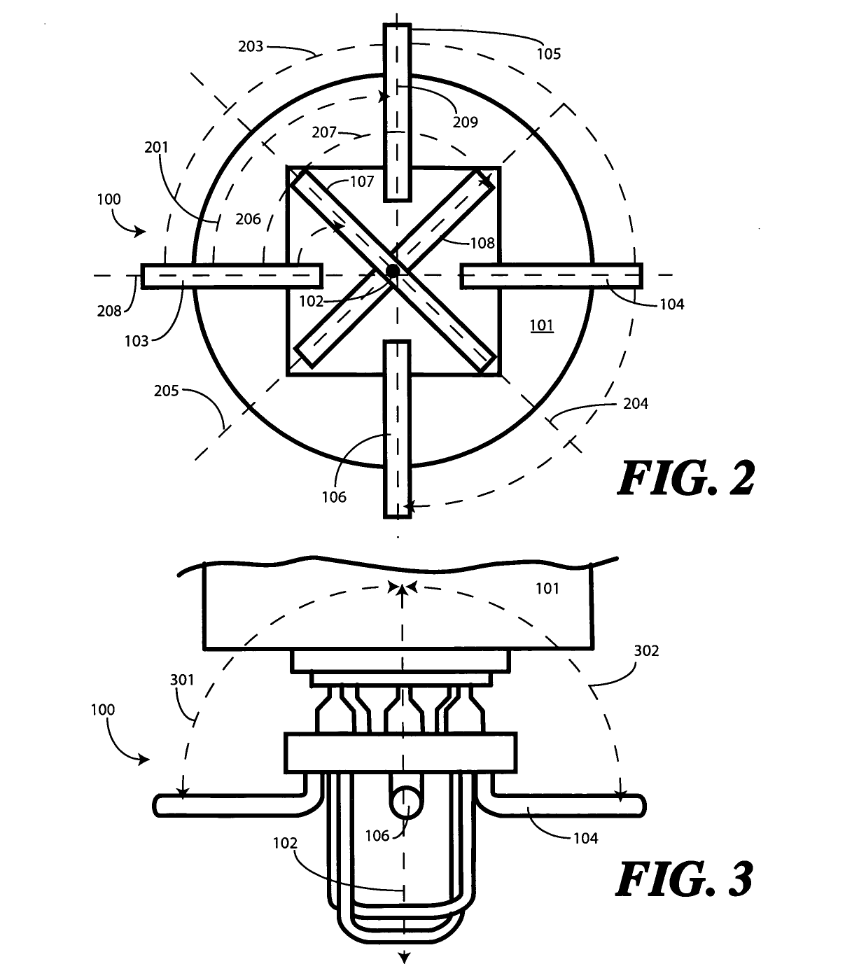

The second pole 104 is disposed on the opposite side of the probe 100 from the first pole 103. In other words, the second pole 104 extends outwardly at an angle 201 (FIG. 2) of between 173.6 and 186.4 degrees relative to the first probe. Note that in the preceding sentence the range is plus or minus 6.4 degrees, as both the first pole 103 and second pole 104 are allotted the 3.2 degree tolerance. In one embodiment the first pole 103 and second pole 104 would be as close to 180 degrees from each other as possible. In another embodiment the angle 201 is between 176.8 and 183.2 degrees.

The probe 100 also includes a second dipole, the second dipole having a third pole 105 and a fourth pole 106. As with the first and second poles 103,104, in one embodiment, the length of the poles 105 and 106 does not exceed one-tenth of a wavelength at the highest frequency of measurement. As with the first and second poles 103,104, the third pole 105 extends outwardly from the central axis 102 at an angle of between 86.8 and 93.2 degrees relative to the central axis 102. The fourth pole 106 also extends outwardly from the central axis 102 at an angle of between 86.2 and 93.2 degrees relative to the central axis 102. The third pole 105 extends outwardly at an angle 202 of between 83.6 and 93.2 degrees relative to the first pole 103, with a range of between 86.8 and 93.2 degrees offering better performance. The fourth pole 106 extends outwardly from the central axis 102 at angle 203 of between 263.6 and 276.4 degrees relative to the first pole 103, with a range of 266.8 and 273.2 degrees offering better performance. As such, the first 103, second 104, third 105 and fourth 106 poles extend outwardly substantially orthogonal to the central axis of the probe, substantially at angles of 90 degrees when viewed relative to the vertical, central axis 102, and substantially at angles of 0, 90, 180 and 270, respectively, when viewed radially, normal to the central axis.

The probe 100 includes a first loop 107 that extends distally from the central member 101 along the central axis 102. To keep the probe small such that it minimally interferes with the signal to be measured, in one embodiment, the circumference of the loop 107 does not exceed one-tenth of a wavelength at the highest frequency of measurement. Since the loop 107 is substantially U-shaped, the bottom and sides of the U may be viewed as establishing a reference plane 204. As the loop 107 extends distally from the central member 101 along the reference axis 102, the reference axis 102 will be substantially along the plane 204, neglecting manufacturing tolerances. The plane 204 defined by the first loop 107 is disposed at an angle 206 between 38.6 and 51.4 degrees relative to the first pole 103, with a range of 41.8 and 48.2 degrees in one embodiment.

The probe 100 also includes a second loop 108 that also extends distally from the central member 101 along the central axis 102. As with loop 107, in one embodiment, the circumference of the loop 108 does not exceed one-tenth of a wavelength at the highest frequency of measurement. The plane 205 defined by the second loop 108 is disposed at an angle 207 between 129.6 and 141.4 degrees relative to the first pole 103, with a range of 131.8 and 138.2 in one embodiment. As with the first loop 107, the second loop 108 is substantially a U-shaped conductor. In one embodiment, the first and second loops 107,108 do not contact each other in the vicinity of central axis 102. In another embodiment, the first and second loops 107,108 are electrically coupled in the vicinity of the central axis.

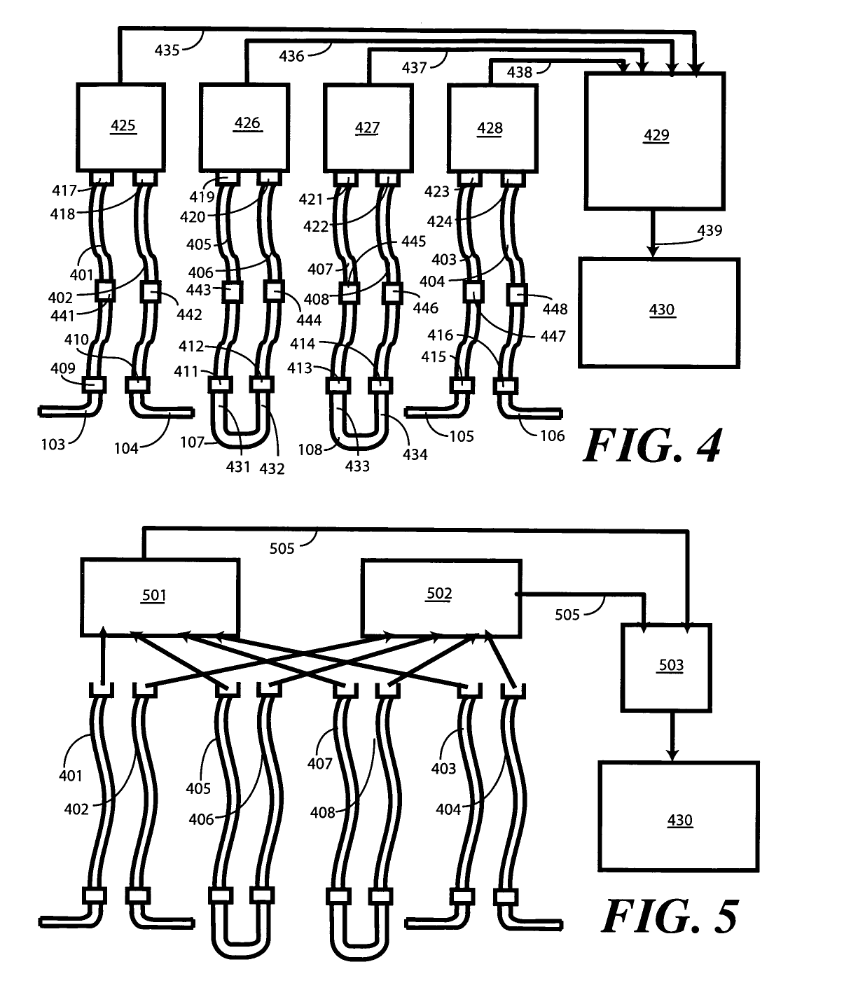

Turning now to FIG. 4, illustrated therein are additional components associated with a probe in accordance with the invention. The poles 103-106 and loops 107-108 from FIGS. 1-3 are illustrated. Each of the poles 103-106 and loops 107-108, as they are conductors, serve as the detectors of electric and magnetic fields tangential to the probe. To facilitate coupling of these fields to something observable by a user, the first pole 103 is coupled to a first flexible conductor 401 by way of a connector 409. In one embodiment, the flexible conductor 401 is a coaxial cable, and the connector 409 is a screw-type or press-fit connector suitable for coupling to a coaxial cable, and any suitable conventional connector can be utilized. The first pole 103 is connectorized so as to couple to the connector 409.

Similarly, the second pole 104 is coupled to a second flexible conductor 402 by way of a connector 410. The third pole 105 is coupled to a third flexible conductor 403 by way of a connector 415, and the fourth pole 106 is coupled to a fourth flexible conductor 404 by way of a fourth connector 416. Any suitable conventional connector can be utilized, such as a screw-type or press-fit connector suitable for coupling to a coaxial cable.

Fields detected by the loops 107-108 must also be transferred, so as to be observable by the user. The first loop 107 has a first side 431 and a second side 432. The first side 431 of the U-shaped conductor that is the first loop 107 is coupled to a fifth flexible conductor 405 by a connector 411. The second side 432 is likewise coupled to a sixth flexible conductor 406 by a connector 412. Similarly, the first side 433 of the second loop 108 is coupled to a seventh flexible conductor 407 by a connector 413. The second side 434 of the second loop 108 is coupled to an eighth flexible conductor 408 by a connector 414.

These flexible conductors 401-408 pass through the central member (101, FIGS. 1-3). In one embodiment, the central member 101 is a hollow metal tube. A suitable material the central member 101 is brass. The central member 101 may be cylindrical, although square cross sections have also been found to work well.

The flexible conductors 401-408 are coupled to a plurality of signal combiners. The term “signal combiner” is used to indicate an electrical circuit or component capable of combining signals from multiple conductors. One such signal combiner is the model 30054, 3 dB, 180 degree Hybrid Coupler manufactured by Anaren. This coupler, sometimes referred to as a “balun” is an aluminum cased, connectorized coupler that receives two signals and vectorially combines them into two outputs. One output is the sum of the two inputs. The other output is the difference of the two inputs. This device is often called a sum-difference hybrid. While this device has been shown to be quite effective, it will be clear to those of ordinary skill in the art having the benefit of this disclosure that the invention is not so limited. Other equivalent circuits or components capable of synthesizing, mixing or otherwise processing the signals may also be employed.

In the exemplary embodiment of FIG. 4, the signals from each of the four respective detectors, i.e. the first dipole 103,104, the second dipole 105,106, the first loop 107 and the second loop 108, is coupled to a separate signal combiner 425, 426, 427, and 428 (FIG. 5 will illustrate an alternate embodiment.) For example the first flexible conductor 401 coming from the first pole 103 and the second flexible conductor 402 coming from the second pole 104 are coupled to the first signal combiner 425. The third flexible conductor 403 coming from the third pole 105 and the fourth flexible conductor 404 coming from the fourth pole 106 are coupled to the second signal combiner 426. Similarly, the fifth flexible conductor 405 coming from the first side 431 of the first loop 107 and the sixth flexible conductor 406 coming from the second side 432 of the first loop 107 are coupled to the third signal combiner 427. Likewise, the seventh flexible conductor 407 coming from the first side 433 of the second loop 108 and the eighth flexible conductor 408 coming from the second side 434 of the second loop 108 are coupled to the fourth signal combiner 428. Note that in one embodiment, to keep manufacture simple and cost effective, the center conductors of the coaxial cables may be stripped and bent to form the dipoles and loops of the probe.

The signal combiners 425-428 vectorially combine the signals. Since these signal combiners 425-428 are 180-degree hybrid couplers, they actually perform a separation function. This separates the difference mode signal from the common mode signal, which represents the radial electric field incident upon the probe. As such the signal combiners 425-428 separate the common mode, yielding only the tangential electric and magnetic fields which are of major interest to the user. The radial electric field may be made available from the sum port of the sum-difference hybrid coupler

Note that the outputs 435-438 of the signal combiners 425-428 could be routed into individual pieces of lab equipment, like spectrum analyzers and vector network analyzers. However, four pieces of equipment are both space consuming and expensive. To simplify, in one embodiment of the invention, the outputs 435-438 of the signal combiners 425-428 are routed into a 4-1 switch 429. The 4-1 switch 429 continuously sweeps the four inputs 435-428 and produces one output 439 that may be coupled to a spectrum or network analyzer 430 for viewing. One suitable 4-1 switch that may be used with the invention is a 4-1 (SP4T) TTL Driver pin diode switch manufactured by Mini-Circuits, Inc. It will be clear to those of ordinary skill in the art having the benefit of this disclosure that other circuits, including additional signal combiners, combinations of switched elements and other processing circuits may be substituted for the 4-1 switch 429 of this exemplary embodiment as the application warrants.

Note that optional decoupling elements 441-448, may be coupled to the conductors to isolate the probe from the lab equipment and thus ensure highly accurate measurements by avoiding undesirable interactions between the central support and the fields being measured. Suitable decoupling elements include choking sleeves and/or ferrite beads. In one embodiment, decoupling sleeves measuring a quarter-wavelength of the center frequency are coupled to the central member to isolate the central member from the probe. Such an embodiment is shown in FIG. 7.

Turning briefly to FIG. 7, illustrated therein is one embodiment of a decoupled probe 700 in accordance with the invention. As illustrated above, the decoupled probe 700 includes the central member 101 through which the conductors or coaxial cables connecting the probe 100 to other equipment pass. One or more Sleeves 702-704 that measure a quarter wavelength of the center frequency of the decoupled band are disposed about the central member 101. While they may be directly coupled to the central member 101, optional dielectric loading material 705 may be disposed between the sleeves 702-704 and the central member 101. The sleeves 702-704 and/or dielectric loading material 705 reduce currents flowing across the central member, thereby isolating the probe 101 so that it may make measurements with improved accuracy.

Alternately, toroids of highly permeable material, often called ferrite beads, may be placed around the central member, a combination of quarter-wave sleeves and ferrite beads may also be used.

Turning now to FIG. 5, illustrated therein is an alternate embodiment of the invention. Rather than employing four signal combiners, as in FIG. 4, a pair of 4-1 switches 501-502 may be used to further reduce the part count. One flexible conductor from each of the first dipole, second dipole, first loop and second loop is connected to the first 4-1 switch, while the second flexible conductor is coupled to the second 4-1 switch. In other words, flexible connectors 401, 403, 405 and 407 are coupled to 4-1 switch 501, while flexible conductors 402, 404, 406 and 408 are coupled to 4-1 switch 502. The outputs of these switches 504,505 are coupled to a single signal combiner 503, which is in turn coupled to a network or spectrum analyzer 430.

To recap, referring now again to FIGS. 1-3, a probe 100 capable of measuring electromagnetic fields tangentially incident to the central axis 102 of the probe 100 is shown in FIGS. 1-3. The probe 100 includes a central member 101, which defines a central axis 102. The probe 100 has a first dipole that includes a first conductor 103 and a second conductor 104, each of which senses field components. The first conductor 103 extends outwardly from the central member 101 at angles that are substantially orthogonal to the central axis 102. While orthogonal is optimal, perfectly orthogonal angles are impossible to manufacture. The term “substantially” is thus used to refer to a range in which sensed field components may be measured with a reasonable amount of error. In one embodiment, this range is plus or minus 3.2 degrees, as this range has been shown to yield results within 0.5 dB of the actual fields present.

The first conductor and second conductor 103,104 are disposed on opposite sides of the central member 101 so as, in one embodiment, to define a first axis (e.g. 208 of FIG. 2) that runs through the first and second conductors 103,104. This first axis 208 is substantially orthogonal to the central axis 102.

A second dipole, which includes a third and a fourth conductors 105,106, is also included. The third and fourth conductors 105,106 extend outwardly from the central member 101 at angles substantially orthogonal to the central axis 102, such that the third conductor 105 and fourth conductor 106 are disposed on opposite sides of the central member 101. In one embodiment, the third and fourth conductors 105,106 form a second axis (209 in FIG. 2) that is substantially orthogonal to both the central axis 102 and the first axis 208.

The probe 100 includes a first loop 107 that may be a U-shaped conductor. The U-shape defines a reference plane 204. The first loop 107 extends distally from the central member 101 along the central axis 102 such that the first plane 204 intersects the first and second axes 208,209 at substantially a 45 degree angle.

A second loop 108, which defines a second reference plane 205, also extends distally from the central member 101 along the central axis 102. The second loop 108, which may also be a U-shaped conductor, is disposed such that the second plane 205 intersects the axes 208,209 at a substantially 45 degree angle. In this position, the second plane 205 is substantially orthogonal to the first plane 204.

Each of the first dipole, the second dipole, the first loop 107 and the second loop 108 are connected to flexible conductors. The flexible conductors pass through the central member 101, which may be a hollow brass tube. As was shown in FIG. 4, the flexible conductors may be coupled to a plurality of signal combiners capable of combining signals received from the dipoles and loops.

In one embodiment, a first signal combiner combines a signals detected by the first and second conductors, while a second signal combiner combines signals detected by the third and fourth conductors. A third signal combiner combines signals from the first and second sides of the first loop, while a fourth signal combiner combines signals from the first and second sides of the second loop. A 4-1 switch takes the output from these signal combiners and routes it to a network or spectrum analyzer.

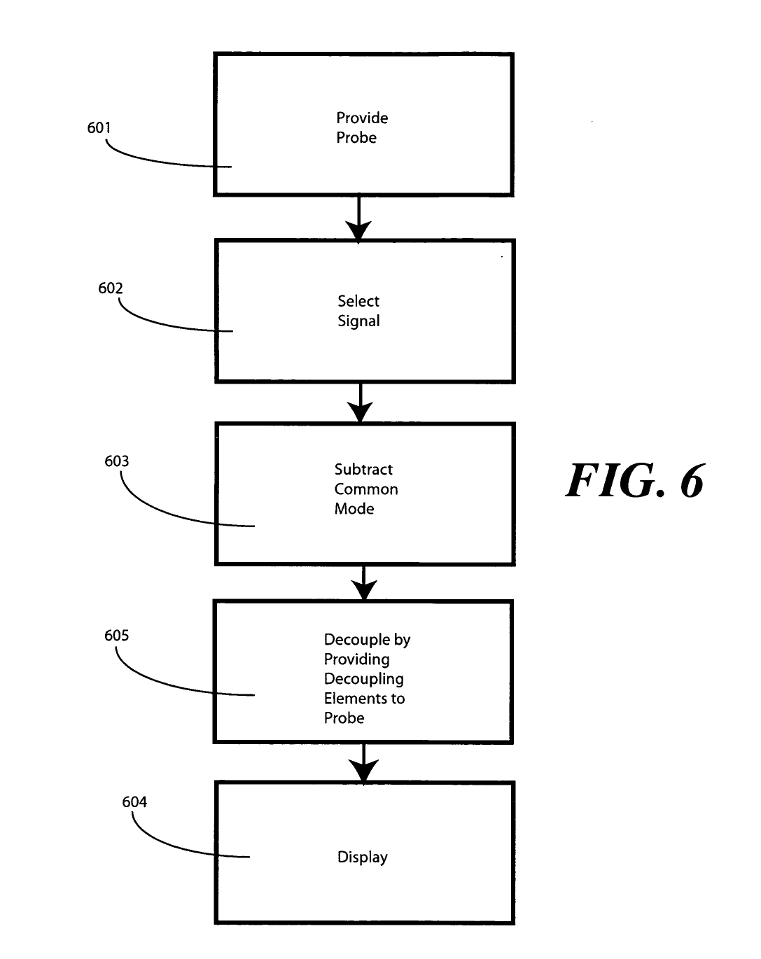

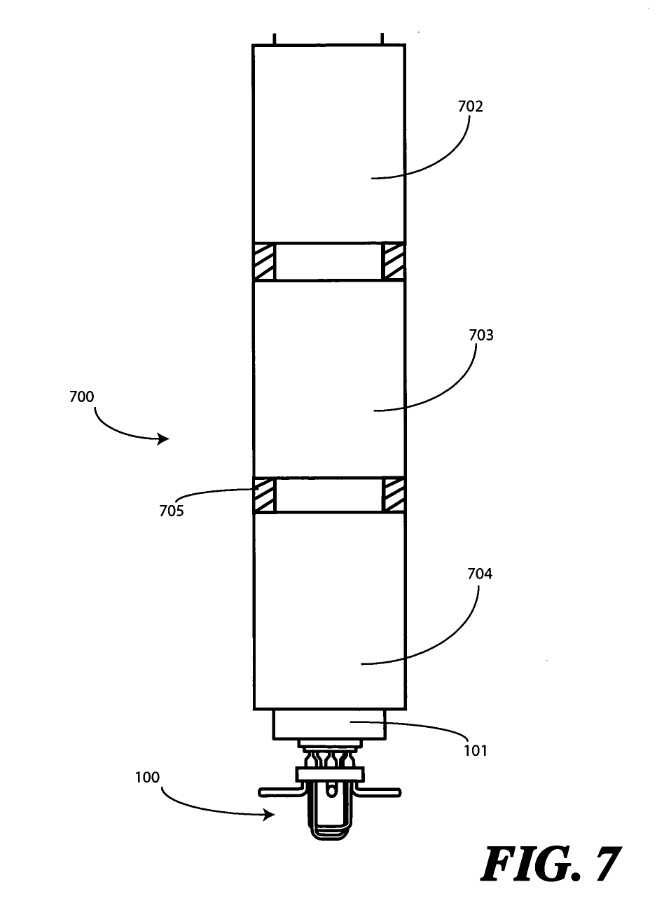

Turning now to FIG. 6, an engineer or lab technician may employ a probe in accordance with the invention as follows: At step 601, the technician positions a probe for measurement. At step 602, the technician selects one or more of the signals from the first dipole, the the second dipole, the the first loop, and the second loop. Note that each of these signals may be automatically or periodically selected by a switch as described above.

At step 603, the common mode element, which represents the component of the field incident to the probe, is subtracted. This subtraction may take place before or after the step of selecting. As discussed above, this may be achieved by employing 3 dB 180-degree hybrid couplers. The resulting switched, common mode-less signal is then displayed on a spectrum analyzer or network analyzer at step 604. Should the technician employ a decoupling mechanism, such as quarter wave chokes or ferrite beads around the central member 101 and about the flexible conductors, the probe may be isolated from the central member at optional step 605.

The loops and dipoles discussed above are used to measure four tangential electromagnetic field components at any one spatial location. Just by way of a brief background, a changing electromagnetic field may be characterized at any one spatial location by six vector quantities: an electric field (Ex) parallel to the conventional X-axis, an electric field (Ey) parallel to the Y-axis, an electric field (Ez) parallel to the Z-axis, a magnetic field (Hx) parallel to the X-axis, a magnetic field (Hy) parallel to the Y-axis, and a magnetic field (Hz) parallel to the Z-axis. Presuming for the moment that the probe is postioned such that its central axis is along the Z-axis of the reference, the probe detectors sensethe amplitude and phase of tangential components of the Ex, Hx, Ey and Hy fields. This is done without the problems associated with the high impedance circuit nodes of the prior art. The probe further delivers spectrum data, rather than simply amplitude. Those skilled in the art will recognize that because the loops are at 45 degree angles relative to the x and y axes, a computer may be used to calculate the Hx and Hy components, when these values are desired.

The probe has numerous applications for designers, engineers, technicians and others. For example, the probe may be used to measure electromagnetic fields near an antenna. The measured fields and detected field quantities may then be used to calculate antenna characteristics such as stored energy, far field efficiency and pattern. The probe measures vector quantities, so that both magnitude and phase of the field is obtained. All of this may be viewed on a spectrum or network analyzer. The probe is simple and compact, so as not to interfere with the field that is it measuring. The sensors of the probe are small, so as to accurately measure the fields in the “near field region” without interfering with the fields themselves.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. An electromagnetic measurement probe, comprising:
a. a central axis;
b. a first dipole comprising a first pole and a second pole, the first pole extending outwardly from the central axis at an angle of between 86.8 and 93.2 degrees relative to the central axis, the second pole extending outwardly from the central axis at an angle of between 86.8 and 93.2 degrees relative to the central axis, wherein the second pole extends outwardly at an angle of between 173.6 and 186.4 degrees relative to the first pole;
c. a second dipole comprising a third pole and a fourth pole; the third pole extending outwardly from the central axis at an angle of between 86.8 and 93.2 degrees relative to the central axis, the fourth pole extending outwardly from the central axis at an angle of between 86.8 and 93.2 degrees relative to the central axis, wherein the third pole extends outwardly at an angle of between 83.6 and 96.4 degrees relative to the first pole, further wherein the fourth pole extends outwardly from the central axis at an angle of between 263.6 and 276.4 degrees relative to the first pole;
d. a first loop extending distally from the central member along the central axis such that a plane defined by the first loop is disposed between 38.6 and 51.4 degrees relative to the first pole; and
e. a second loop extending distally from the central member along the central axis such that a plane defined by the second loop is disposed between 129.6 and 141.4 degrees relative to the first pole.

2. The electromagnetic measurement probe of claim 1, wherein the first loop and second loop comprise U-shaped conductors.

3. The electromagnetic measurement probe of claim 2, further comprising:
a. a first flexible conductor coupled to the first pole;
b. a second flexible conductor coupled to the second pole;
c. a third flexible conductor coupled to the third pole; and
d. a fourth flexible conductor coupled to the fourth pole;

4. The electromagnetic measurement probe of claim 3, wherein a first side of the U-shaped conductor comprising the first loop is coupled to a fifth flexible conductor; wherein a second side of the U-shaped conductor comprising the first loop is coupled to a sixth flexible conductor; wherein a first side of the U-shaped conductor comprising the second loop is coupled to a seventh flexible conductor; and wherein a second side of the U-shaped conductor comprising the second loop is coupled to an eighth flexible conductor.

5. The electromagnetic measurement probe of claim 4, further including a central member comprises a hollow metal tube.

6. The electromagnetic measurement probe of claim 4, wherein the first and second flexible conductors are coupled to a first signal combiner; wherein the second and third flexible conductors are coupled to a second signal combiner; wherein the fourth and fifth flexible conductors are coupled to a third signal combiner; and wherein the seventh and eighth flexible conductors are coupled to a fourth signal combiner.

7. The electromagnetic measurement probe of claim 6, wherein the first signal combiner, second signal combiner, third signal combiner and fourth signal combiner are coupled to a four-to-one switch.

8. The electromagnetic measurement probe of claim 7, wherein the four-to-one switch is coupled to a device selected from the group consisting of spectrum analyzers and network analyzers.

9. The electromagnetic measurement probe of claim 1, wherein the second pole extends outwardly from the central axis at an angle of between 176.8 and 183.2 degrees relative to the first pole.

10. The electromagnetic measurement probe of claim 9, wherein the third pole extends outwardly at an angle of between 86.8 and 93.2 degrees relative to the first pole, further wherein the fourth pole extends outwardly from the central axis at an angle of between 266.8 and 273.2 degrees relative to the first pole.

11. The electromagnetic measurement probe of claim 10, wherein the first loop extends distally from the central member along the central axis such that the plane defined by the first loop is disposed between 41.8 and 48.2 degrees relative to the first pole.

12. The electromagnetic measurement probe of claim 11, wherein the second loop extends distally from the central member along the central axis such that the plane defined by the second loop is disposed between 131.8 and 138.2 degrees relative to the first pole.

13. A probe capable of measuring electromagnetic fields tangentially incident to a central axis of the probe, the probe comprising:
a. a central axis;
b. a first dipole, the first dipole comprising a first conductor and a second conductor, the first conductor and second conductor extending outwardly from the central member at angles substantially orthogonal to the central axis, such that the first conductor and second conductor are disposed on opposite sides of the central member so as to define a first axis substantially orthogonal to the central axis;
c. a second dipole, the second dipole comprising a third conductor and a fourth conductor, the third conductor and fourth conductor extending outwardly from the central member at angles substantially orthogonal to the central axis, such that the third conductor and fourth conductor are disposed on opposite sides of the central member so as to define a second axis substantially orthogonal to both the central axis and the first axis;
d. a first loop, the first loop comprising a first U-shaped conductor, the first U-shaped conductor defining a first plane, wherein the first U-shaped conductor extends distally from the central member along the central axis such that the first plane interests the first and second axes at a substantially 45 degree angle;
e. a second loop, the second loop comprising a second U-shaped conductor, the second U-shaped conductor defining a second plane, wherein the second U-shaped conductor extends distally from the central member along the central axis such that the second plane intersects the axes at a substantially 45 degree angle, wherein the second plane is substantially orthogonal to the first plane; and
f. at least one decoupling element coupled to a component selected from the group consisting of the central member, the first dipole, the second dipole, the first loop and the second loop.

14. The probe of claim 13, further comprising a central member, the central member comprising a metal tube, further wherein the decoupling elements are selected from the group consisting of choking sleeves and ferrite beads, further wherein the decoupling elements are coupled to the central member.

15. The probe of claim 14, wherein each of the first dipole, second dipole, first loop and second loop are coupled to first ends of coaxial cables that run through the metal tube.

16. The probe of claim 13, further comprising at least four signal combining couplers, wherein:
a. a first signal combiner combines signals detected by the first conductor and the second conductor;
b. a second signal combiner combines signals detected by the third conductor and the fourth conductor;
c. a third signal combiner combines signals detected by a first side of the first U-shaped conductor and a second side of the first U-shaped conductor; and
d. a fourth signal combiner combines signals detected by a first side of the second U-shaped conductor and a second side of the second U-shaped conductor.

17. The probe of claim 16, further comprising a four-to-one switch, wherein the four-to-one switch is coupled to an output of the first signal combiner, an output of the second signal combiner, an output of the third signal combiner and an output of the fourth signal combiner.

18. The probe of claim 17, wherein the four-to-one switch is coupled to an item selected from the group consisting of spectrum analyzers and network analyzers.

19. A method for measuring both tangentially incident electric and magnetic fields, the method comprising the steps of:
a. providing a probe comprising:
i. a central axis;
ii. a first dipole having a first pole extending substantially perpendicularly from the central axis and a second pole extending substantially perpendicularly from the central axis, the second pole being disposed on an opposite side of the central member from the first pole;
iii. a second dipole having a third pole extending substantially perpendicularly from the central axis and a fourth pole extending substantially perpendicularly from the central axis, wherein a line defined by the third pole is substantially perpendicular to the first pole; further wherein the fourth pole is disposed on an opposite side of the central member from the third pole;
iv. a first loop extending distally from the central member, such that the first loop defines a first plane, the first plane intersecting the line defined by the third pole at a substantially 45 degree angle; and
v. a second loop extending distally from the central member, such that the second loop defines a second plane, the second plane interesting the first plane at a substantially perpendicular angle;
b. selecting a signal from the group consisting of a combined signal from the first pole and the second pole, a combined signal from the third pole and the fourth pole; a combined signal from a first side of the first loop and a second side of the first loop, and a combined signal from a first side of the second loop and a second side of the second loop;
c. isolating a common mode element from the signal; and
d. displaying the signal on a machine selected from the group consisting of spectrum analyzers and network analyzers.

20. The method of claim 19, further comprising the step of decoupling a first signal from a second signal, wherein the first and second signals are each selected from the group consisting of a difference from the first pole and the second pole, a difference signal from the third pole and the fourth pole; a difference signal from a first side of the first loop and a second side of the first loop, and a difference signal from a first side of the second loop and a second side of the second loop.
